(19) United States
(12) Patent Application Publication
(10) Pub. No.: US 2017/0148302 A1
(43) Pub. Date: May 25, 2017

(54) TECHNIQUES FOR PROVIDING A SEAMLESS BREAK REMINDER IN THE MULTI-DEVICE AND MULTI-USER ENVIRONMENT

(71) Applicant: International Business Machines Corporation, Armonk, NY (US)

(72) Inventors: Su LIU, Austin, TX (US); Eric J. ROZNER, Austin, TX (US); Cliff SZE, Austin, TX (US); Yaoguang WEI, Austin, TX (US)

(21) Appl. No.: 14/945,675

(22) Filed: Nov. 19, 2015

(51) Int. Cl. G08B 21/24; G08B 21/18

(52) U.S. Cl. CPC G08B 21/24; G08B 21/182

(57) ABSTRACT

Techniques are disclosed for providing a break reminder in a multi-device and multi-user environment. A management service monitors usage activity of one or more devices by a first user in a plurality of users. Each of the one or more devices is associated with the first user. An amount of weighted use time of each user on one or more devices (from a first point in time to a second point in time) is determined based on the usage activity. Upon determining that the amount of time exceeds a specified threshold amount of time, the management service generates a break reminder. The management service sends the break reminder to at least one of the one or more devices currently being used.

### BACKGROUND

The present disclosure generally relates to user management, and more specifically, to providing a break reminder to a user in a multi-device and multi-user environment.

Modern technology provides individuals with a wealth of devices that serve various purposes. For example, in an enterprise setting, it is not uncommon for a user to multi-task between a desktop computer, a smartphone, and a tablet computer during a regular work day. Each device may provide functionality that is distinct from other devices. For instance, a tablet computer provides mobility in situations where the user must work away from a desk. Smartphones allow the user to call colleagues and send messages on-the-go. During a work day, users may often switch between devices to suit whatever needs they may have at the moment.

Although devices such as computers, tablets, phones, and televisions provide users with convenience and utility, a user may spend a considerable amount of time between the devices without a reasonable amount of rest. Doing so without taking regular breaks can be detrimental to the health of the user, e.g., prolonged work in front of a desktop computer can result in degradation of eyesight, poor posture, wrist pain, etc. Therefore, effective approaches to remind a user to rest while using such devices is desirable.

### SUMMARY

One embodiment presented herein discloses a method for providing a break reminder in a multi-device and multi-user environment. The method generally includes monitoring, via a processor, usage activity of one or more devices by a first user in a plurality of users. Each of the one or more devices is associated with the first user. The method also includes determining an amount of use time based on the usage activity from a first point in time to a second point in time. Upon determining that the amount of use time exceeds a specified threshold amount of time, a break reminder is generated. The break reminder is sent to at least one of the one or more devices. The at least one of the one or more devices is currently being used by the first user.

Other embodiments include, without limitation, a computer program product that includes a non-transitory storage medium having computer-readable program code that enables a processing unit to implement one or more aspects of the disclosed methods as well as a system having a processor, memory, and application programs configured to implement one or more aspects of the disclosed methods.

### BRIEF DESCRIPTION OF THE SEVERAL VIEWS OF THE DRAWINGS

So that the manner in which the above-recited features of the present disclosure can be understood in detail, a more particular description of the disclosure, briefly summarized above, may be had by reference to the embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates an example computing environment, according to one embodiment.

FIG. 2 illustrates an example usage monitor configured to observe user activity in a device, according to one embodiment.

FIG. 3 illustrates a management service configured to evaluate usage activity of a user associated with a device, according to one embodiment.

FIG. 4 illustrates an example flow describing an interaction between a usage monitor of a user device with a management service.

FIG. 5 illustrates a method for providing a break reminder in a multi-device and multi-user environment, according to one embodiment.

FIG. 6 illustrates an example user device configured to provide a break reminder in a multi-device and multi-user environment, according to one embodiment.

FIG. 7 illustrates an example backend server configured to provide a break reminder in a multi-device and multi-user environment, according to one embodiment.

### DETAILED DESCRIPTION

Embodiments presented herein disclose techniques for providing a seamless break reminder to one or more user devices. More specifically, techniques provide a usage monitor executing on each of the user devices. The usage monitor in each user device communicates with a back-end service executing on a server (e.g., hosted by a cloud computing provider). In one embodiment, the usage monitor collects activity conducted by the user on the device. For example, assume that the device is a desktop computer and that the user is currently modifying a document in a word processor application executing on the device. In such a case, the usage monitor may determine, based on this activity, that the user is actively using the desktop computer, the user is typing in a document file, and that the activity is productivity-related. The usage monitor may also track an active use time of such activity.

In one embodiment, the usage monitor sends the activity data and active use time to the management service. The management service receives activity and active use time data from each device associated with a given user. Further, the management service may weight the active use time from each device and add the weighted use time to a timer associated with that user. The weighting methods may be based on various factors, such as the type of device, a type of work being performed, and a type of content of the work being performed. For example, thirty minutes of watching an instructional video may be weighted less than thirty minutes of writing code in an application. The timer accumulates weighted use time from each of the devices. The management server may determine, based on the timer and specified user settings, whether to generate a break reminder notification. That is, the timer exceeding a specified threshold amount of time may indicate that the user has been interacting with the devices for a prolonged period of time and should take a break. Further, the management server may reset the global timer for that user after a specified amount of time of idle activity on each of the devices. However, in the event that the timer exceeds the specified threshold of time, the management server may generate a break reminder notification. The management server sends the break reminder notification to each device that the user is currently operating.

In turn, the device may instruct the user to take a break. As an example, the device may provide a pop-up message in a display of the device. The device may periodically display the message until the user complies with the reminder (e.g., by allowing the associated devices to idle for a specified period of time). As another example, the device may temporarily disable functionality to prevent the user from continuing to operate the device for a specified amount of time. At any rate, the device presents the break reminder notification to the user. Further, any device associated with the user may present the break reminder to the user, even if the user switches between devices. For instance, when the user switches to another device while the timer exceeds the threshold amount, the management service receives a notification that the user is currently using that device. The backend service then sends the break reminder to the device, which can also instruct the user to take a break. After the user has complied with the break reminder, the management service may reset the timer and send a notification to each device to remove the break reminder.

In one embodiment, the management service may target a break reminder to a particular user on a multi-user device (i.e., a device associated with multiple users). For example, assume that the multi-user device is a television being watched by users A, B, and C. The usage monitor may detect activity of each user via sensors in the television (e.g., through eye-recognition techniques). The management service may determine that the timer associated with user B exceeds a specified threshold. In such a case, the management service sends a break reminder notification targeted at user B to the usage monitor. The usage monitor may then present a break reminder to user B, e.g., through a message targeted at user B in the display.

Embodiments presented herein disclose a network-based (e.g., via a cloud computing network) approach to monitoring usage activity across multiple devices associated with a user and delivering a break reminder to a user through the devices after a certain amount of time. Advantageously, using a backend management service to track and weight usage time across the devices provides a seamless method for determining an amount of time that a user is operating the devices during a given period, even as the user switches devices during that period.

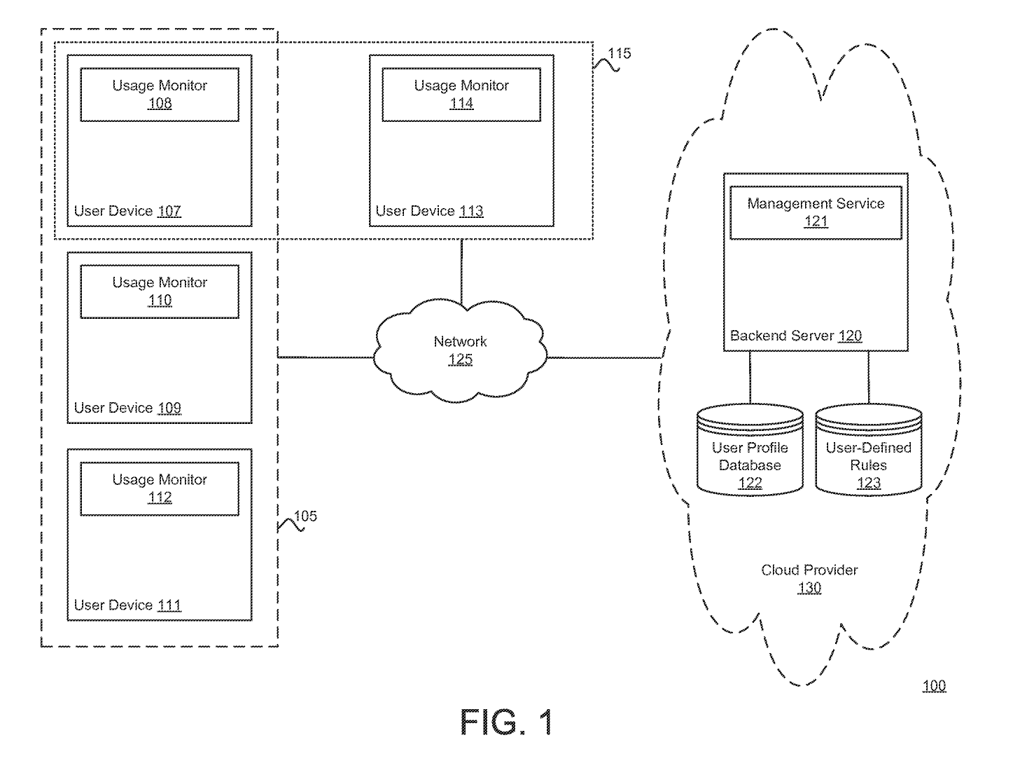

FIG. 1 illustrates an example computing environment 100, according to one embodiment. As shown, computing environment 100 includes a set of user devices 105, a set of user devices 115, and a cloud provider 130, each interconnected with a network 125. In one embodiment, computing environment 100 is representative of an enterprise network. Of course, embodiments presented herein may be adaptable to various types of network environments. In one embodiment, network 125 corresponds to the Internet.

As shown, the set of user devices 105 includes user devices 107, 109, and 111. The set of user devices 105 may be associated with a given user in the enterprise (e.g., based on a corresponding user profile). Similarly, the set of user devices 115, which includes user devices 107 and 113, may be associated with another user in the enterprise. The user devices in sets 105 and 115 may correspond to a variety of devices, such as desktop computers, laptop computers, smartphones, tablet computers, wearable devices, and the like. Further, a device can be associated with multiple users. Illustratively, user device 107 belongs in sets 105 and 115. An example in which a device is associated with multiple users is for a television, where multiple users can operate the television at the same time.

In one embodiment, each of the user devices 107, 109, 111, and 113 include a usage monitor 108, 110, 112, and 114, respectively. Each of the usage monitors 108, 110, 112, and 114 collect activity data in the respective user devices. For example, assume that the user device 109 is a smartphone. The usage monitor 110 may capture information such as open applications, rate of touch screen use, open content, etc. As further described below, the usage monitor 110 may also predict, based on such information, the type of work occurring on the user device 109 (e.g., typing, reading, streaming videos, etc.).

In one embodiment, the cloud provider 130 includes a backend server 120. The backend server 120 further includes a management service 121, a user profile database 112, and a set of user-defined rules 123. Each of the usage monitors 108, 110, 112, and 114 communicate with the management service 121. As further described below, the management service 121 continuously receives activity data from usage monitors associated with a given user and determines, based on the activity data over time, when to generate a break reminder and send the reminder to the associated user devices. The management service 121 may determine an appropriate amount of time for user activity prior to generating the break reminder based on a user profile (stored in the database 122) and on settings specified in the configurable user-defined rules 123 for the corresponding user profile. The user-defined rules 123 may also specify an amount of time at which a user should take a break.

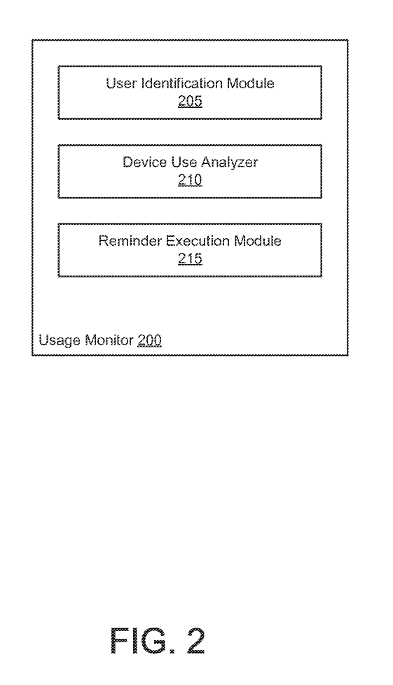

FIG. 2 illustrates an example usage monitor 200 configured to observe user activity in a device, according to one embodiment. As shown, the usage monitor 200 includes a user identification module 205, a device use analyzer 210, and a reminder execution module 215.

In one embodiment, the user identification module 205 determines an identity of a user currently operating the device. For example, at initialization of the usage monitor 200, the user identification module 205 may request identification credentials of the user, e.g., a username and password. In other devices, such as wearable devices, the user identification module 205 may identify a user based on biometric information, e.g., fingerprint identification, voice recognition, facial recognition, and the like. The user identification module 205 may send the identification information to the management service to indicate that the identified user is currently operating the device.

The device use analyzer 210 collects activity data of the user. The activity data may include work type, content type, and use time. For example, work type can include a type of activity that the user is doing with the device, such as typing, reading, coding, playing games, etc. The device use analyzer 210 can identify such activity based on pre-defined rules and operating system messages. For some devices that do not often receive user input, e.g., televisions, the device use analyzer 210 may use eye-tracking techniques to confirm that the user is currently using the device (e.g., watching the television). Further, content type describes types of files or media currently open and actively being consumed or worked on, such as news, research papers, audio, video, etc. Further still, use time describes an amount of time that the user is engaged with the activity from a starting period. The device use analyzer 210 sends the activity data to the management service.

The reminder execution module 215 receives break reminder notifications from the management service 121. A break reminder notification may be targeted at the user of the device. The notification may indicate how long the user should refrain from using any of the associated devices (e.g., based on user-defined rules 123). In response to receiving a break reminder notification, the reminder execution module 215 may generate a break reminder on the device. For example, the reminder execution module 215 can present a pop-up message on a display of the device instructing the user to take a break. As another example, the reminder execution module 215 can temporarily disable functionality of the device until the user has complied with the break reminder. In some cases, a user may configure user-defined settings on how to handle break reminders on each associated device.

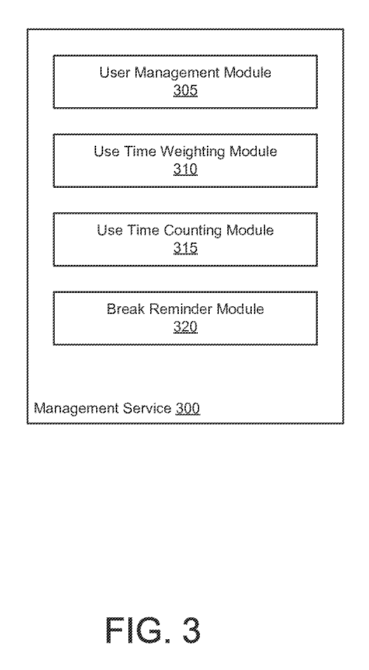

FIG. 3 illustrates an example management service 300 configured to evaluate usage activity of a user associated with a device, according to one embodiment. As shown, the management service 300 includes a user management module 305, a use time weighting module 310, a use time counting module 315, and a break reminder module 320.

In one embodiment, the user management module 305 receives user identification information from a usage monitor. The user management module 305 may verify the user information relative to a user profile database stored in the cloud provider network. Once verified, the user management module 305 may start (or resume) a timer associated with the corresponding user.

The use time weighting module 310 receives usage activity data, including use time, from the usage monitor. The use time weighting module 310 weights the use time based on the accompanying activity data. For example, the use time weighting module 310 may weight the use time based on the type of underlying device, the work type, the content type, and user-defined settings. For example, watching television is typically less strenuous than writing code on a desktop computer. Therefore, assuming that the received use time for both activities is equal, the use time weighting module 310 may weight watching television lower compared to writing code on the desktop computer. As another example, reading an academic paper may generally cause a user to tire more quickly than reading a news article. As a result, the use time weighting module 310 may weight reading an academic paper higher compared to reading a news article. Of course, a user may adjust the user-defined settings based on personal preferences. In one embodiment, weighted time Tₜₒₜₐₗ_{_}ᵤₛₑ may be expressed as:

$${T}_{total \_ use} = {\sum }_{ijk}^{ } ( {w}_{device}^{i} {w}_{work}^{j} {w}_{content}^{k} {T}_{ijk} )$$

where w_{device}ⁱ is the weight of device i, w_{work}^{j} the weight of work type j, w_{content}^{k} is the weight of content k, and Tᵢⱼₖ is the active use time spent on device i, work type j, and content k.

The use time counting module 315 may add the weighted use time to the timer associated with the user. Further, the use time counting module 315 may reset the user timer after a specified period of time during which the devices associated with the user send no usage activity data to the management service 400.

The break reminder module 320 determines whether the user timer exceeds a specified threshold amount of time. Further, the break reminder module 320 may generate a break reminder notification in the event once determining that the user timer exceeds the threshold amount of time. The break reminder notification may include information such as the user being targeted for the break reminder, a period of time for the break, usage statistics, etc. The break reminder module 320 may then send the break reminder notification to devices currently being operated by the user (e.g., as determined by the user management module 305). The break reminder module 320 may also send the break reminder notification module 305 to other devices of the user if the user switches devices during the period where the user timer exceeds the threshold amount of time. To do so, the user management module 305 may notify the break reminder module 320 that a user has switched devices. In turn, the break reminder module 320 sends the reminder to the new device.

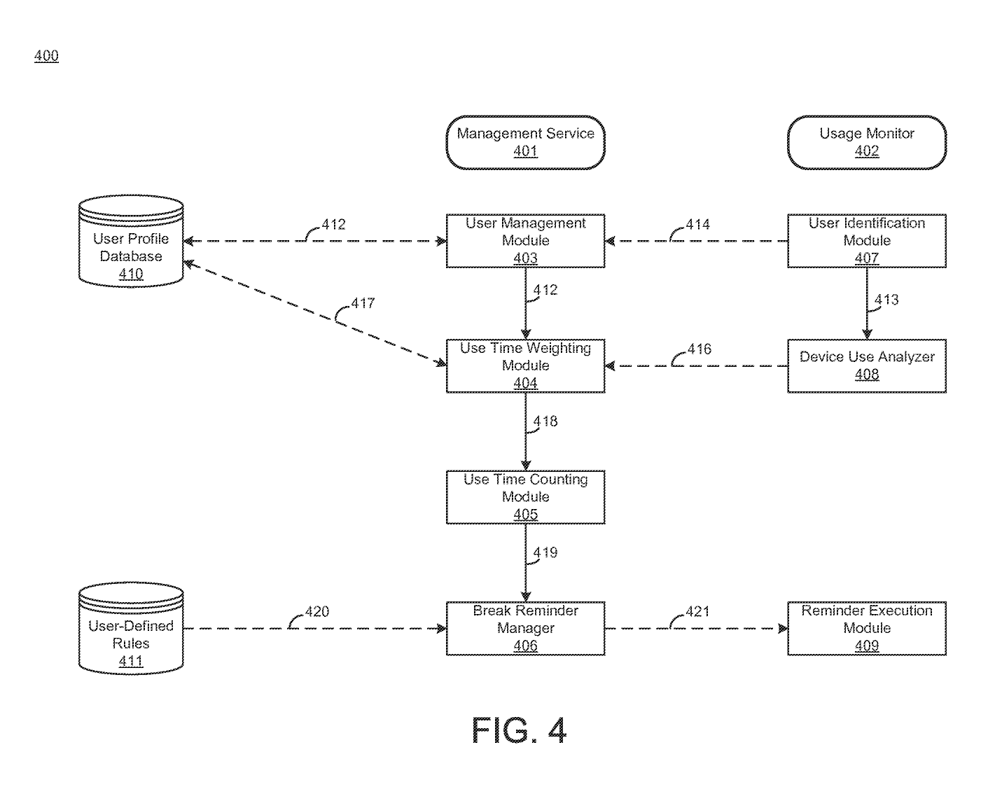

FIG. 4 illustrates an example flow 400 describing an interaction between a usage monitor of a user device with a management service. More specifically, the flow 400 describes a flow between a management service 401 and a usage monitor 402 for a given device. In this example, assume that the usage monitor 402 executes in a desktop computer and that the user sends identification credentials to the usage monitor 402 through the desktop computer. At 412, a user identification module 407 sends the identification credentials to a user management module 403. At 413, the user management module 403 confirms user and device registration with a user profile database 410. Once confirmed, the user management module 403 communicates to a use time weighting module 404 that the user is currently signed into the usage monitor 402 of the desktop computer device. Further, the user management module 403 initializes (or resumes) a timer for the user. In turn, at 417, the use time weighting module 404 retrieves the corresponding user profile information from the user profile database.

The device use analyzer 408 collects activity data from the desktop computer (e.g., keypresses, application information, use time, etc.). At 416, the device use analyzer 408 sends the activity data to the use time weighting module 404. The use time weighting module 404 weights a total use time based on work type, content type, device type, and user-specified settings. At 418, the use time weighting module sends a weighted use time to a use time counting module 405. The use time counting module 405 adds the weighted use time to the user timer and passes the timer to a break reminder manager 406 (at 419).

The break reminder manager 406 determines whether an amount of time specified in the timer exceeds a threshold amount of time (obtained from user-defined rules 411, at 420). If so determined, the break reminder manager 406 generates a break reminder. At 421, the break reminder manager 406 sends the break reminder to the reminder execution module 409. In turn, the reminder execution module 409 performs a specified action to remind the user to take a break (e.g., generating a pop-up message on a display of the desktop computer, closing a window, etc.).

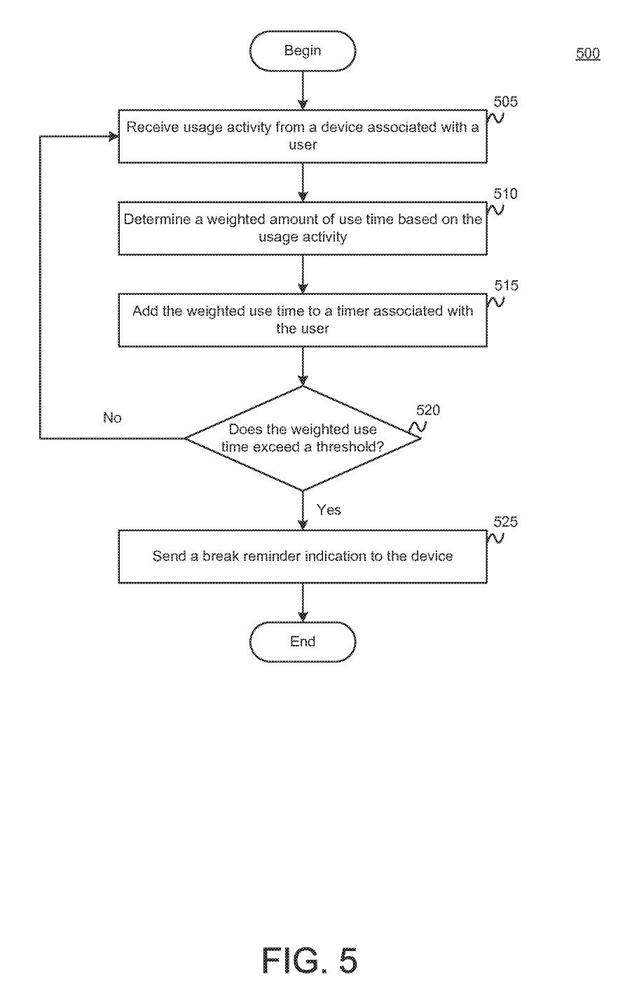

FIG. 5 illustrates a method 500 for providing a break reminder in a multi-device and multi-user environment, according to one embodiment. In particular, method 500 describes the process of providing a break reminder via a management service executing on a backend server in a cloud provider network. In this example method, the components of the management service 300 are described.

As shown, method 500 begins at step 505, where the use time weighting module 310 receives usage activity data from a device usage monitor. In this example, assume that the device is a smartphone. The activity data may include a use time, device type, work type, and content type. For instance, the work type may be typing on a touch screen, and the content type may be e-mail messages. The activity data may indicate that the user is writing e-mail messages for an hour.

At step 510, the use time weighting module 310 determines a weighted amount of use time based on the activity data. As stated, the weighting may be based on a number of factors, such as the device type, work type, content type, and user-defined settings. For example, the use time weighting module 310 may weight writing e-mails on a smartphone to be relatively high.

At step 515, the use time counting module 315 adds the weighed use time to a user-associated timer. At step 520, the break reminder manager determines whether the amount of time specified by the timer exceeds a threshold amount of time. If not, then the method 500 returns to step 505, where the use time weighting module 310 continues to receive usage activity data. Otherwise, then at step 525, the break reminder manager generates a break reminder notification and sends the break reminder notification to the device.

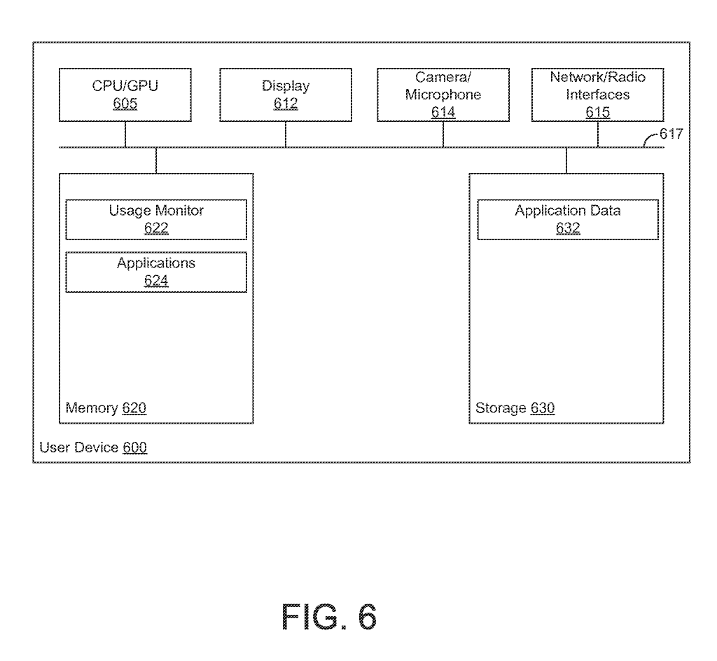

FIG. 6 illustrates an example user device 600 configured to provide a break reminder in a multi-device and multi-user environment, according to one embodiment. In this example, the user device 600 corresponds to a mobile device, such as a smartphone or tablet computer. As shown, the user device 600 includes, without limitation, a central processing unit and graphics processing unit (CPU/GPU) 605, a display 612, a camera/microphone 614, network/radio interfaces 615, an interconnect 617, a memory 620, and a storage 630. Of course, an actual user device 600 will include a variety of additional hardware components.

The CPU/GPU 605 retrieves and executes programming instructions stored in the memory 620. Similarly, the CPU-GPU 605 stores and retrieves application data 632 residing in the storage 630. The interconnect 617 is used to transmit instructions and data between the CPU/GPU 605, storage 630, network/radio interfaces 615, and the memory 620. CPU/GPU 605 is included to be representative of a single CPU, multiple CPUs, a single CPU having multiple processing cores, and the like. And the memory 620 is generally included to be representative of memory and storage on a mobile device, e.g., DDR and flash memory spaces.

Illustratively, the memory 620 includes a usage monitor 622 and one or more applications 624. The storage includes application data 632 representative of data specific to the applications 624. In one embodiment, the usage monitor 622 collects activity data (e.g., use time, work type, content type, device information, usage on the applications 624) and sends the activity data to a backend management service executing in a host residing in a cloud provider network. The usage monitor 622 may receive break reminder notifications from the management service in the event that a weighted use time on the device (and other devices associated with the user) exceeds a specified amount of time. In such an event, the usage monitor 622 may execute a break reminder on the user device 600 (e.g., generating a pop-up window, terminating an application 624, temporarily disabling device functionality, etc.).

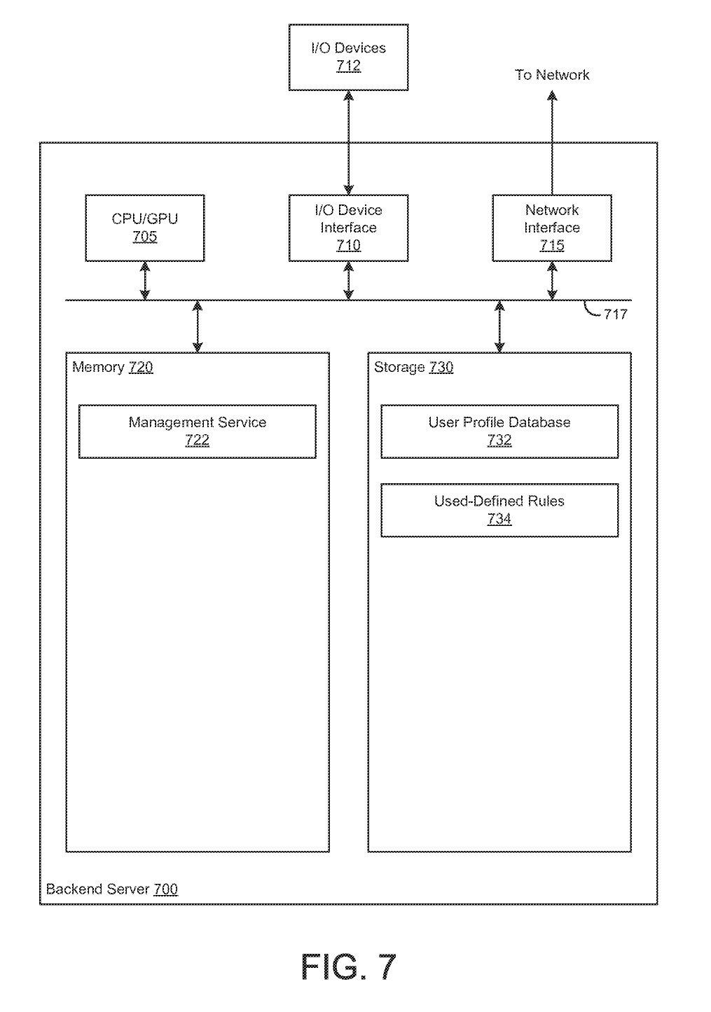

FIG. 7 illustrates an example backend server 700 configured to provide a break reminder in a multi-device and multi-user environment, according to one embodiment. As shown, the backend server 700 includes, a central processing unit (CPU) 705, a network interface 715, a memory 720, and storage 730, each connected to a bus 717. The backend server 700 may also include an I/O device interface 710 connecting I/O devices 712 (e.g., keyboard, display and mouse devices) to the backend server 700. Further, in context of this disclosure, the computing elements shown in the backend server 700 may correspond to virtualized components of a server instance hosted in a cloud network. In other embodiments, the backend server 700 may correspond to a physical computing system.

CPU 705 retrieves and executes programming instructions stored in memory 720 as well as stores and retrieves application data residing in the storage 730. The bus 717 is used to transmit programming instructions and application data between CPU 705, I/O devices interface 710, storage 730, network interface 717, and memory 720. Note, CPU 705 is included to be representative of a single CPU, multiple CPUs, a single CPU having multiple processing cores, and the like. Memory 720 is generally included to be representative of a random access memory. Storage 730 may be a disk drive storage device. Although shown as a single unit, storage 730 may be a combination of fixed and/or removable storage devices, such as fixed disc drives, removable memory cards, or optical storage, network attached storage (NAS), or a storage area-network (SAN).

Illustratively, memory 720 includes a management service 722. And storage 730 includes a user profile database 732 and user-defined rules 734. The management service 722 is a backend application that communicates with usage monitors executing in devices associated with a user (e.g., identified in a profile stored in the user profile database 732). The management service 722 stores user identities and profiles in the user profile database 732. Further, the management service 722 maintains user-defined rules 734 that store information related to device usage, allowed usage time periods, break periods, and the like. The management service 722 receives activity data from a device and weights use time related to the activity data. The management service 722 may add the weighed use time to a timer associated with that user. If the timer exceeds a specified threshold (e.g., specified in user-defined rules 734 associated with that user), then the management service 722 generates a break reminder targeted to that user and sends the break reminder to the device.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications (e.g., the management service) or related data available in the cloud. For example, the management service could execute on a computing system in the cloud and collect usage activity data across multiple devices associated with a user. In such a case, the management service could generate break reminder notifications to send to the multiple devices and store user profile and rules data at a storage location in the cloud. Doing so allows a user to access this information from any computing system attached to a network connected to the cloud (e.g., the Internet).

While the foregoing is directed to embodiments of the present disclosure, other and further embodiments of the present disclosure may be devised without departing from the basic scope thereof, and the scope thereof is determined by the claims that follow.

What is claimed is:

1. A method for providing a break reminder in a multi-device and multi-user environment, the method comprising:
monitoring, via a processor, usage activity of one or more devices by a first user in a plurality of users, wherein each of the one or more devices is associated with the first user;
determining an amount of use time based on the usage activity from a first point in time to a second point in time;
upon determining that the amount of use time exceeds a specified threshold amount of time, generating a break reminder; and
sending the break reminder to at least one of the one or more devices, wherein the at least one of the one or more devices is currently being used by the first user.

2. The method of claim 1, wherein the usage activity includes at least one of a type of each of the one or more devices, a type of work being conducted on each of the one or more devices, a type of content activity being conducted on each of the one or more devices, and specified settings associated with the first user.

3. The method of claim 2, wherein the amount of use time is weighted based on the type of each of the one or more devices, the type of work, the type of content, and the specified settings.

4. The method of claim 1, wherein each of the plurality of users is associated with a respective timer, wherein the timer tracks the amount use of time based on the usage activity.

5. The method of claim 4, further comprising:
receiving an indication that the first user complied with the break reminder; and
resetting the timer.

6. The method of claim 1, wherein the at least one of the one or more devices is being used by the first user and at least a second user simultaneously, and wherein the break reminder is targeted at the first user and not at the at least the second user.

7. The method of claim 1, wherein monitoring the usage activity of the one or more devices by the first user comprises:
tracking, via one or more sensors, whether the first user is actively using the one or more devices.

8. A computer program product, comprising:
a non-transitory computer-readable storage medium having computer-readable program code embodied therewith, the computer-readable program code configured to perform an operation for providing a break reminder in a multi-device and multi-user environment, the operation comprising:
monitoring, via a processor, usage activity of one or more devices by a first user in a plurality of users, wherein each of the one or more devices is associated with the first user,
determining an amount of use time based on the usage activity from a first point in time to a second point in time,
upon determining that the amount of use time exceeds a specified threshold amount of time, generating a break reminder, and
sending the break reminder to at least one of the one or more devices, wherein the at least one of the one or more devices is currently being used by the first user.

9. The computer program product of claim 8, wherein the usage activity includes at least one of a type of each of the one or more devices, a type of work being conducted on each of the one or more devices, a type of content activity being conducted on each of the one or more devices, and specified settings associated with the first user.

10. The computer program product of claim 9, wherein the amount of use time is weighted based on the type of each of the one or more devices, the type of work, the type of content, and the specified settings.

11. The computer program product of claim 8, wherein each of the plurality of users is associated with a respective timer, wherein the timer tracks the amount of use time based on the usage activity.

12. The computer program product of claim 11, wherein the operation further comprises:
receiving an indication that the first user complied with the break reminder; and
resetting the timer.

13. The computer program product of claim 8, wherein the at least one of the one or more devices is being used by the first user and at least a second user simultaneously, and wherein the break reminder is targeted at the first user and not at the at least the second user.

14. The computer program product of claim 8, wherein monitoring the usage activity of the one or more devices by the first user comprises:
tracking, via one or more sensors, whether the first user is actively using the one or more devices.

15. A system, comprising:
a processor; and
a memory storing a program, which, when executed on the processor, performs an operation for providing a break reminder in a multi-device and multi-user environment, the operation comprising:
monitoring usage activity of one or more devices by a first user in a plurality of users, wherein each of the one or more devices is associated with the first user,
determining an amount of use time based on the usage activity from a first point in time to a second point in time,
upon determining that the amount of use time exceeds a specified threshold amount of time, generating a break reminder, and
sending the break reminder to at least one of the one or more devices, wherein the at least one of the one or more devices is currently being used by the first user.

16. The system of claim 15, wherein the usage activity includes at least one of a type of each of the one or more devices, a type of work being conducted on each of the one or more devices, a type of content activity being conducted on each of the one or more devices, and specified settings associated with the first user.

17. The system of claim 16, wherein the amount of use time is weighted based on the type of each of the one or more devices, the type of work, the type of content, and the specified settings.

18. The system of claim 15, wherein each of the plurality of users is associated with a respective timer, wherein the timer tracks the amount of use time based on the usage activity.

19. The system of claim 18, wherein the operation further comprises:
receiving an indication that the first user complied with the break reminder; and
resetting the timer.

20. The system of claim 15, wherein the at least one of the one or more devices is being used by the first user and at least a second user simultaneously, and wherein the break reminder is targeted at the first user and not at the at least the second user.
